(19) United States
(12) Patent Application Publication
(10) Pub. No.: US 2020/0107549 A1
(43) Pub. Date: Apr. 9, 2020

(54) Enhancement of seed germination and plant growth under conditions of stress with pterostilbene, ellagic acid, nicotinamide riboside, and their combinations.

(71) Applicant: Ananya Ranjani Subramanian, Los Altos Hills, CA (US)

(72) Inventor: Ananya Ranjani Subramanian, Los Altos Hills, CA (US)

(21) Appl. No.: 16/056,422

(22) Filed: Aug. 6, 2018

(51) Int. Cl. A01N 43/90; A01N 43/40; A01N 31/14

(52) U.S. Cl. CPC A01N 43/90; A01N 31/14; A01N 43/40

(57) ABSTRACT

Improvement in seed germination and seed aging represents a major unmet need in the field of agriculture. In this specification it was hypothesized that the use of natural compounds to enhance mitochondrial functions in seed cells can enable germination under unfavorable conditions, specifically water deprivation and temperature excursions. It was demonstrated that three compounds, nicotinamide riboside (NR), ellagic acid (EA), and pterostilbene (PS) have independent effects on improving seed germination and plant growth at low concentrations. Additionally, their combinations were shown to have synergistic effects. This utility patent covers the usage of these compounds as single agents and in combinations to enhance seed health to facilitate germinations and plant growth and prevent seed aging.

### BACKGROUND

### Field of the Invention

The invention relates to the fields of seed treatments and crop growth. Specifically, the present disclosure relates to the use of natural compounds, such as nicotinamide riboside, ellagic acid, pterostilbene, and their combinations, to enhance seed germination and plant growth under conditions of osmotic and temperature stress.

### Background and Prior Art

The negative effects of inefficient seed germination span from the molecular to the societal level. Only 6% of agricultural biomass globally is consumed as food, with the largest absolute loss occurring at the food production stage, even before crop harvesting (Alexander and Rounsevell, et. al. 2017). As seed germination is characterized by a significant increase in energy requirements and associated increase in mitochondrial activity (mitochondria being the “powerhouses” of cells which produces energy through cellular respiration), plant seeds with inefficient mitochondria require additional resources in order to germinate and grow effectively. Thus, especially under conditions of stress, such as water deprivation or extreme temperatures, there is a clear need for efficient mitochondrial functioning to enhance seed germination and ultimately create a “smarter” system of food resource management.

There are two physiological functions that are critical for optimal mitochondrial activity. Mitophagy is the degradation of defective, inefficient mitochondria, and mitochondrial biogenesis is the creation of new, efficient mitochondria. Both are key to cellular health and optimization of ATP or energy production.

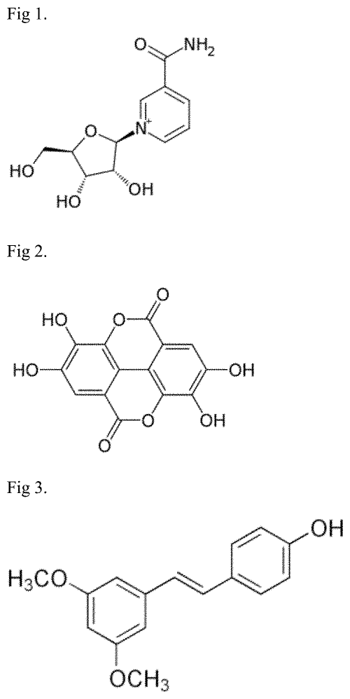

Nicotinamide riboside (NR), as shown in FIG. 1, is a precursor to NAD, nicotinamide dinucleotide, in the cell. NAD+ is a key constituent of the redox reactions required for energy (ATP) production during cellular respiration, and also serves as a substrate for enzymes that are involved in mitophagy, called sirtuins (Imai S, et. al. 2014). In several animal species, NR supplementation has consistently been shown to increase longevity and promote stem cell function (Zhang H et. al. 2016).

Pterostilbene (PS), shown in FIG. 2, and ellagic acid (EA), shown in FIG. 3, are natural plant products which have been shown to enhance mitochondrial function in animals. While the precise function of pterostilbene, a stilbenoid derivative, is not known, it is hypothesized to be another sirtuin agonist which plays a central role in the regulation of cellular physiology and mitochondrial biogenesis (Yi-Rong Li, et. al. 2017). Ellagic acid, a phenol derivative of ellagitannin commonly found in berries and pomegranates, has been shown recently shown to enhance mitophagy in animal cells (Ryu D, et. al. 2016).

Currently, there is neither published literature nor patent data on the use of these compounds in enhancing mitochondrial function in plants, and their subsequent effects on seed germination. Furthermore, the current understanding of the role of the mitochondria in seed aging is in its infancy. The effects of these compounds in seed germination and for the prevention of seed aging have not been investigated, with the exception of a recent report on the effects of EA in chickpeas (Abu W, et. al. 2013). U.S. Pat. No. 8,756,861 describes a method of germinating seeds containing water-soluble polyphenols (including ellagic acid), but does not describe its effect on rate of germination or the effects of the compound on mitochondrial function or seed aging (Ochiai; Koji, et. al. 2014).

The present invention examines the use of these specific natural plant products that are known to enhance mitochondrial function in animal cells on seed germination and plant growth, with the hypothesis that these compounds may play a similar role in plants. The use of germination as the end point has practical value and is easy to measure. The hypothesis was that improved mitochondrial function would translate to higher rates of seed germination. Given the importance of mitochondria in adapting to environmental stressors, it was plausible that these compounds would have the maximal benefit under conditions that are sub-optimal for seed germination.

Additional advantages of the invention will be set forth in the description which follows, as well as in drawings and through experimental data provided below.

### BRIEF SUMMARY OF THE INVENTION

Enhancing the efficiency of seed germination, especially under suboptimal conditions, will address the increasing need for “smarter” management of food resources. The concept of utilizing natural compounds made by plants (NR, EA, PS, and their combinations) to enhance the growth of plants provides an eco-friendly but effective solution. The rationale for the selection of these specific compounds to address mitochondrial function and its impact on seed germination and seed aging was determined through research on their published effects on animal cells.

The present invention examines the effects of different concentrations of NR, EA, PS and their combinations on the rapidity of seed germination and plant growth under conditions of water restriction and extreme temperature in different plant species. The specific aims were to investigate the rapidity and rate of seed germination in different seed species (including but not limited to tomato, okra, cucumber, and rice) following 24 hr incubation with different concentrations of NR, EA, and PS solutions, and explore the effects of combinations of these compounds on seed germination.

### BRIEF DESCRIPTION OF SEVERAL VIEWS OF THE INVENTION

FIG. 1: structure of nicotinamide riboside.

FIG. 2: structure of ellagic acid.

FIG. 3: structure of pterostilbene.

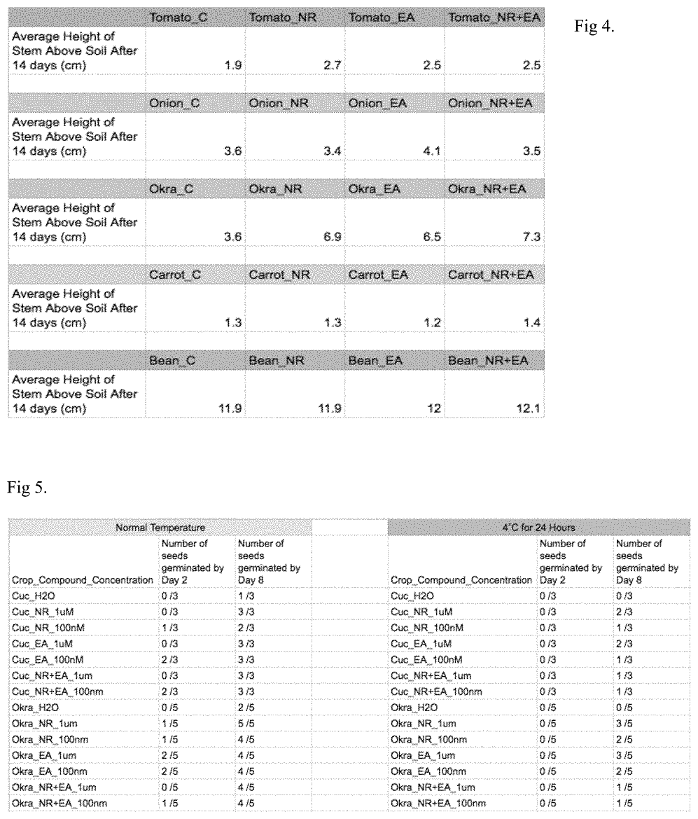

FIG. 4: table depicting plant growth of 5 species of plants incubated in H2O, NR, EA, and NR+EA—tomato, onion, okra, carrot, and green bean

FIG. 5: table depicting number of okra and cucumber seeds germinated over time

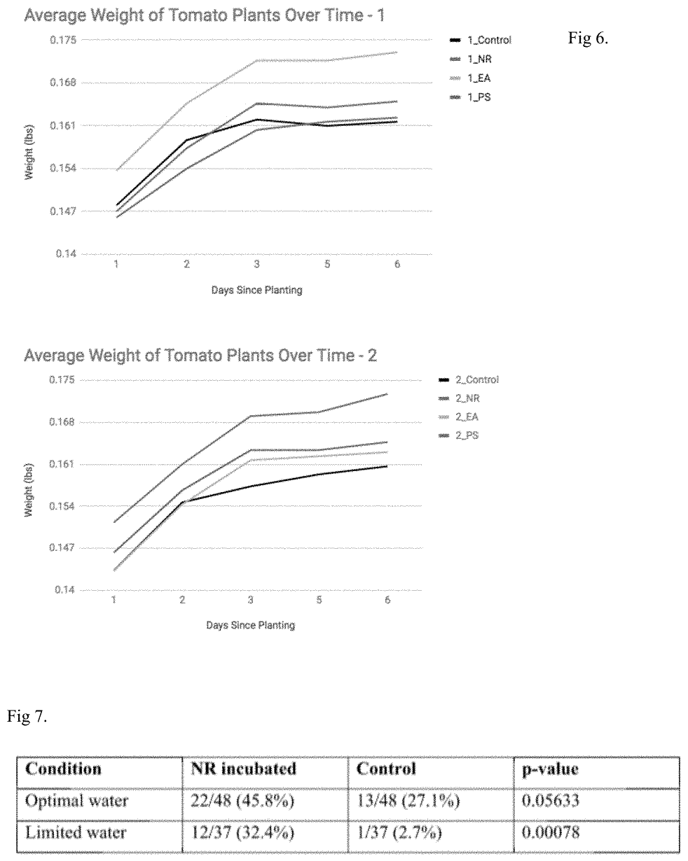

FIG. 6: tomato plant experiment data—weight of tomato plants over 6 days

FIG. 7: rice seed experiment data, including statistical significance

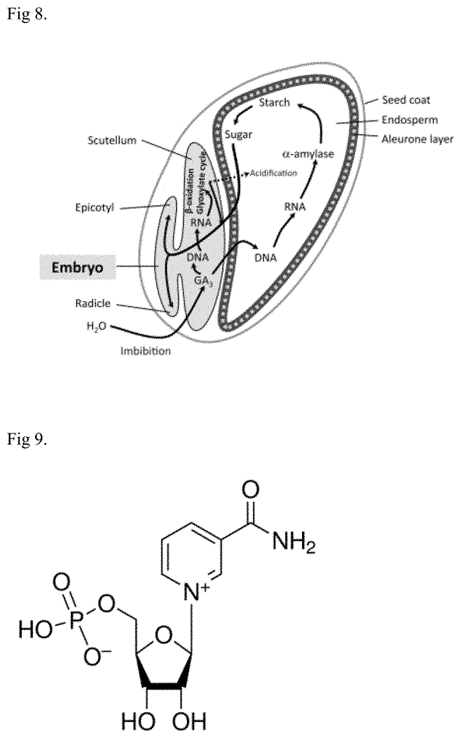

FIG. 8: metabolic processes occurring in embryo and endosperm during barley seed germination

FIG. 9: structure of NMN, nicotinamide mononucleotide

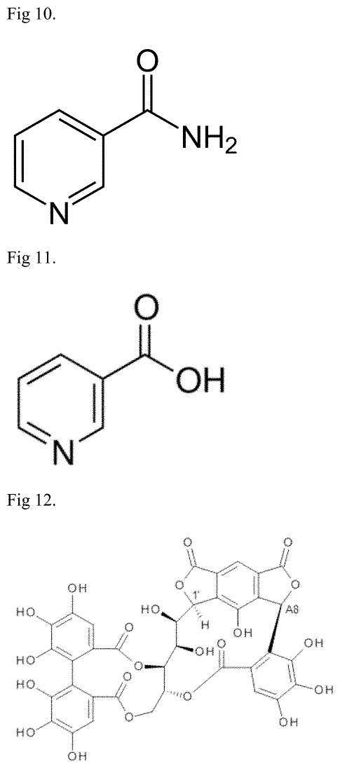

FIG. 10: structure of nicotinamide

FIG. 11: structure of nicotinic acid

FIG. 12: structure of ellagitannin

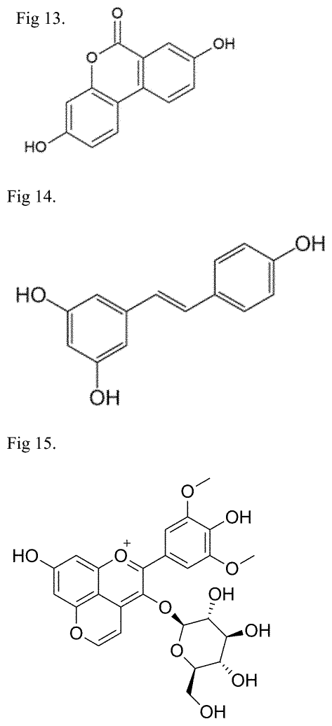

FIG. 13: structure of urolithin A

FIG. 14: structure of resveratrol

FIG. 15: structure of stilbenoid (vitisin B)

### DEFINITIONS

As used herein, the following terms and phrases shall have the meanings set forth below. Unless defined otherwise, all technical and scientific terms used herein have the same meaning as commonly understood to one of ordinary skill in the art.

Conditions of “water deprivation” in this specification refers to the administration of less water than required for a seed to germinate typically. In the experiments described below, seeds subjected to a condition of “water deprivation” were given 2 mL of water 3 times a week, as opposed to 5 mL. In the rice experiment, the seeds subjected to “water deprivation” were not given any water after their planting in the artificial paddy.

A “naturally occurring compound” or “natural compound” refers to a compound that can be found in nature and has not been designed by man. Nicotinamide riboside, ellagic acid, and pterostilbene are examples of naturally occurring compounds. A naturally occurring compound can however be made both by man or by nature.

“Nicotinamide riboside,” abbreviated as “NR,” is a niacin-derived, pyridine-nucleoside that functions as a precursor to nicotinamide adenine dinucleotide or NAD+. It is naturally found in milk and yeast. Its derivatives include NMN (nicotinamide mononucleotide), shown in FIG. 9, nicotinamide, shown in FIG. 10, and nicotinic acid, shown in FIG. 11.

“Ellagic acid,” abbreviated as “EA,” is a polyphenol derived from ellagitannins (the general structure of which depicted in FIG. 12) that functions as a metabolic precursor to Urolithin A, depicted in FIG. 13, as well as Urolithin B, C, and D. It is naturally found in many fruits and vegetables.

“Pterostilbene,” abbreviated to “PS,” is a stilbenoid (shown in FIG. 15) belonging to the family of phenylpropanoids, and is chemically related to resveratrol, shown in FIG. 14. It is naturally found in certain berries and nuts.

“Plant pathogens” are any agents, including but not limited to fungi, oomycetes, bacteria, viruses, viroids, virus-like organisms, phytoplasmas, protozoa, nematodes and parasitic plants, which cause infectious diseases in plants.

### DETAILED DESCRIPTION OF THE INVENTION

The present invention is directed to the uses of pterostilbene, ellagic acid, nicotinamide riboside, and their combinations, as pharmaceutical compositions to enhance and accelerate seed germination, enhance plant growth, and prevent seed aging. In an embodiment of the present invention, the seeds are treated with solutions comprising NR, EA, PS, and their combinations. The amount of the solutions should be enough to wet the seeds. In the experiments described below, seeds were soaked in approximately 5 mL of solution. The compositions of the present invention may be applied as a slurry or soak; however, film coating and encapsulation may also be used. The methods of application of the compositions of the present invention may be varied, and the invention is intended to include any technique that is to be used by one of skill in the art.

The following examples are intended to illustrate the present invention and to teach one of ordinary skill in the art how to make and use the invention. They are not intended to be limiting in any way.

### Plant Seeds

Seeds tested included the following:

Solanum lycopersicum (Roma Tomato), Solanum lycopersicum (Beefstake Tomato), Solanum lycopersicum (Cherry Tomato), Allium cepa (Walla walla onion), Abelmoschus esculentus (Okra), Phaseolus vulgaris (Green beans), Cucumis sativus (Cucumber), Daucus carota (nantes carrot), Oryza sativa (Rice), and Zea mays (Corn).

### Preparation of Solutions for Seed Incubation

Dilutions of 1 micromolar (micro M) and 100 nanomolar (nM) were prepared for each of the 3 compounds. Based on the molecular weight of each of the compounds, a specific amount of each compound was dissolved in 100 mL of water in a beaker and thoroughly stirred using a magnetic stir bar until the contents were fully dissolved. Serial dilutions were performed to develop stock solutions.

### Incubation of Seeds

5 mL of the solutions of the 3 compounds or combinations was placed in a small size weigh boats, along with water as the control. Up to 50 seeds were placed in the weigh boats. Incubation periods ranged from 18-24 hours at room temperature (recorded range of 55-65° F.). The seeds were then either placed in a germination chamber or planted in potting soil, as described below.

### Germination Chambers

These were made using a sterile petri dish and filter paper. Two filter papers were placed inside each petri dish. The filter papers were moistened with 5 mL of water using a pipette, before placing in 3-5 seeds. The lids and the base of the petri dish were labeled to avoid errors. The petri dishes were left at room temperature (recorded temperature between 55-70° F.). Observations were made on a daily basis and the time to germination was recorded and photographed.

### Plant Growth

Dixie cups were filled up to the 3 inch mark with soil. Seeds that were incubated in different compound solutions (as previously described) were then planted at a depth of approximately ½ inch in each cup. The number of seeds per cup ranged from 2-4. Water was added to each cup (5 mL) at this stage, and the weight of each cup was recorded. Weight was recorded at the time of watering; either 7.5 mL (regular watering) or 3.75 mL (reduced watering) on Mon/Wed/Friday respectively. Observations were made daily until seed germination and significant plant growth was observed.

For the rice plants, an artificial paddy field was built using two plastic bins filled with soil, and filled with water to a depth of 4 inches. A divider comprising of sticks was placed to delineate the experimental conditions comparing water soaked seeds or NR soaked seeds. In one paddy, water was replenished until germination was observed; the other received no added water. The bins were left outside for a total of 6 weeks; the daily temperatures ranged between 50 F to 95 F, and no rainfall was recorded during the experimental period.

### Experimental Data

The first experiment measured plant growth of 5 different species of plants after seeds were soaked in 4 different experimental groups: H2O (control), 1 uM NR, 1 uM EA, and 1 uM NR+EA. The plants grown were Solanum lycopersicum (Roma Tomato), Allium cepa (Walla walla onion), Abelmoschus esculentus (Okra), Phaseolus vulgaris (Green beans), and Daucus carota (nantes carrot). Average plant height above soil level was recorded over the span of 2 weeks. The data from this experiment is shown in FIG. 4.

The greatest difference between the control and experimental groups in terms of plant height was observed in the bean and okra plants. This was hypothesized to be due to the fact that these plants, especially okra, require the greatest amount of water, and so enhancement of mitochondrial function in those seeds had a greater impact on plant growth as they were (unintentionally) in a state of water deprivation.

This experiment provided the rationale to test the compounds on okra and cucumber seed germination, two plants which require a lot of water to germinate and grow. Seeds were incubated in different concentrations of NR and EA and their combinations. One experimental group was exposed to normal room temperature after incubation, while the other was kept at 4° C. for a period of 24 hours before placed in germination chambers. The number of seeds germinated after two and eight days of being in the germination chamber, receiving 5 mL of water every other day, is shown in FIG. 5.

While the majority of seeds in the “normal temperature” group had germinated by day 8, there is still a considerable difference between those soaked in the compounds and those in the control group (1 out of 3 and 2 out of 5 versus 3/3 and 5/5). However, what was even more surprising was the effect the compounds had on the seeds kept at an extremely cold temperature. While 0 seeds in either control group had germinated by day 8, over 50% of the seeds soaked in 1 uM of NR or EA had germinated. This further supported the hypothesis that enhancement of mitochondrial function would have the greatest impact on seeds exposed to conditions of stress, in this case, in terms of air temperature.

The next experiment conducted tested extremely low concentrations of the three compounds, NR, EA, and PS, on tomato seeds. Seeds were soaked in solutions of 100 nM before planted, and average weight of the cups was recorded over the course of 6 days. The average weight of the tomato plants is represented in the graphs of FIG. 6.

Two species of tomato plants were tested: in the first group, Beefstake tomato seeds were planted, and in the second, Cherry tomato seeds were planted. Although the average weight at day one of each of the experimental groups varied slightly, the difference in new plant biomass, represented by the positive change in weight, was greater in all seed groups incubated in one of the three compounds than those in the control group. In the graphs, this is also represented by the fact that in the first experimental group, the black line representing weight of the control group plants decreased after day three (most likely due to the fact that there was a temperature increase that day and a few plants in the control group died), and that the control group had the smallest end weight after 6 days.

A final experiment was then conducted involved rice, a plant species which requires an immense amount of water to germinate and grow. There were 4 experimental groups: in one artificial paddy which was kept flooded, 48 seeds were incubated in water prior to planting and 48 were incubated in a solution of 1 micromolar NR. In the other artificial paddy, which was initially flooded but not given any water afterwards, 37 seeds were incubated in water prior to planting and 37 were incubated in a solution of 1 micromolar NR.

As shown in FIG. 7, only 1 seed germinated in the control group of the “water deprivation” paddy. However, it was shocking to find that 32% of the seeds soaked in NR in the “water deprivation” paddy germinated, compared to 27% in the control group of the optimal water paddy, as though the NR-soaked seed group had not been subject to a condition of “drought” at all.

The data above supports the hypothesis that these compounds (NR, EA, and PS) and their combinations, administered in concentrations as low as 100 nanomoles per liter, enhance seed germination, not only under normal conditions but especially under conditions of water deprivation and temperatures outside the seeds' ideal range.

The diagram in FIG. 8 portrays the metabolic processes occurring in embryo and endosperm during barley seed germination (Zhenguo Ma et. al. 2017). The hypothesis to support the results demonstrating enhanced seed germination is the following: as shown in the figure, the seed has 2 compartments, namely the endosperm and the embryo. Germination is characterized by a feedback loop whereby increased water content in the embryo triggers a cascade of gene expression ultimately resulting in enhanced metabolic activity in the mitochondria such as beta-oxidation. The production of ATP provides the necessary energy requirements for embryo growth. In the presence of compounds such as NR, ellagic acid and pterostilbene, mitochondrial activity is more efficient, particularly under conditions of water deprivation. In this specification, it is hypothesized that seeds imbibe these compounds, with resulting enhanced energy production, and the effects are most significant with combinations of these compounds. In addition to these favorable effects under conditions of stress, not only is seed germination accelerated and enhanced, but seed aging is also prevented.

### REFERENCES

The following citations are herein incorporated as references:
1. Abu, W, et al. “Ability of Ellagic Acid to Alleviate Osmotic Stress on Chickpea Seedlings.” Advances in Pediatrics, U.S. National Library of Medicine, October 2013.
2. Alexander, Peter, and Mark Rounsevell. “Losses, Inefficiencies and Waste in the Global Food System.” Egyptian Journal of Medical Human Genetics, Elsevier Ltd, 16 Feb. 2017.
3. Bonkowski, M S, and D A Sinclair. “Slowing Ageing by Design: the Rise of NAD+ and Sirtuin-Activating Compounds.” Advances in Pediatrics, U.S. National Library of Medicine, November 2016.
4. Carrie, Chris, et al. “How Do Plants Make Mitochondria?” SpringerLink, Springer, Dordrecht, 14 Sep. 2012.
5. Chini, C C, et al. “NAD and the Aging Process: Role in Life, Death and Everything in between.” Advances in Pediatrics, U.S. National Library of Medicine, 5 Nov. 2017.
6. Fu, Yong-Bi, et al. “Towards a Better Monitoring of Seed Ageing under Ex Situ Seed Conservation.” Advances in Pediatrics, U.S. National Library of Medicine, 1 Jul. 2015.
7. Imai, S, and L Guarente. “NAD+ and Sirtuins in Aging and Disease.” Advances in Pediatrics, U.S. National Library of Medicine, August 2014.
8. Law, Simon, et al. “Mitochondrial Biogenesis in Plants during Seed Germination.” Mitochondrion, U.S. National Library of Medicine, November 2014.
9. Li, Yi-Rong, et al. “Effect of Resveratrol and Pterostilbene on Aging and Longevity.” Wiley Digital Archives, International Union of Biochemistry and Molecular Biology, 6 Dec. 2017.
10. Ma, Zhenguo, et al. “Cell Signaling Mechanisms and Metabolic Regulation of Germination and Dormancy in Barley Seeds.” Egyptian Journal of Medical Human Genetics, Elsevier, 5 Oct. 2017.
11. Ochiai, Koji, and Nobuko Ueda. Germinated Seeds Possessing Increased Water-Soluble Polyphenols and Method of Manufacturing. 24 Jun. 2014.
12. Ryu, D, et al. “Urolithin A Induces Mitophagy and Prolongs Lifespan in C. Elegans and Increases Muscle Function in Rodents.” Advances in Pediatrics, U.S. National Library of Medicine, August 2016.
13. Yan, D, et al. “The Functions of the Endosperm during Seed Germination.” Advances in Pediatrics, U.S. National Library of Medicine, September 2014.
14. Zhang, H, et al. “NAD⁺ Repletion Improves Mitochondrial and Stem Cell Function and Enhances Life Span in Mice.” Advances in Pediatrics, U.S. National Library of Medicine, 17 Jun. 2016.

What is claimed is:

1. A method of accelerating germination or increasing crop yield by applying nicotinamide riboside, ellagic acid, pterostilbene, and their combinations to seeds.

2. A method for enhancing seed germination as defined in claim 1, under normal conditions of water and temperature controls. “Normal” conditions refer to the average range of temperature and water required for a seed to germinate.

3. A method for enhancing crop growth as defined in claim 1, under conditions of water deprivation—this includes drought, reduced water supply, etc.

4. A method for enhancing crop growth as defined in claim 1, under conditions of extreme temperature. This includes any temperature range outside of the “normal” range of temperature ideal for seed germination.

5. A method for enhancing crop growth as defined in claim 1, under conditions of varying water salinity administered to the plants.

6. A method for enhancing crop growth as defined in claim 1, under conditions of extreme pH values of water—when water administered is outside the ideal range of pH values for seed germination.

7. A method for enhancing crop growth as defined in claim 1, under conditions of extreme pH values of soil—when the soil the seeds are planted in is outside the ideal range of pH values for seed germination.

8. A method for enhancing crop growth as defined in claim 1, by applying the compounds in solutions of 1 micromolar concentration.

9. A method for enhancing crop growth as defined in claim 1, by applying the compounds in solutions of 100 nanomolar concentration.

10. A method for enhancing crop growth as defined in claim 1, by applying the compounds in any solution of concentration greater than 100 picomolar.

11. A method for enhancing crop growth as defined in claim 1 by the prevention of plant diseases or plant pathogens by the compounds and their combinations.

12. A method for enhancing crop growth as defined in claim 1, wherein combinations of compounds include: NR+EA, NR+PS, EA+PS, and NR+EA+PS.

13. A method of accelerating germination or increasing crop yield by applying nicotinamide riboside, ellagic acid, pterostilbene, and their combinations to seeds through seed incubation.

14. A method for enhancing crop growth as defined in claim 11, wherein seeds are soaked in solutions of these compounds.

15. A method for enhancing crop growth as defined in claim 11, wherein seeds are coated with these compounds to create a “seed pellet.”

16. A method for enhancing crop growth as defined in claim 11, wherein seeds are first planted in soil and subsequently administered a solution or solutions of the aforementioned compounds.

17. A method for enhancing crop growth as defined in claim 11, wherein seeds are “nicked” or “scarred” first before incubated in a solution or solutions of the aforementioned compounds.

18. The claims 1 through 17, including the usage of nicotinamide, nicotinic acid, nicotinamide mononucleotide, NRH, and other related derivatives of nicotinamide riboside (FIGS. 9, 10, 11).
